(19) United States
(12) Patent Application Publication
(10) Pub. No.: US 2020/0341336 A1
(43) Pub. Date: Oct. 29, 2020

(54) OPTICAL FILM ASSEMBLIES

(71) Applicant: 3M INNOVATIVE PROPERTIES COMPANY, St. Paul, MN (US)

(72) Inventors: Tri D. Pham, Woodbury, MN (US); Corey D. Balts, Eau Claire, WI (US); Felix B Bierbaum, New Richmond, WI (US); Encai Hao, Woodbury, MN (US); Simon P. Janeczko, Colfax, WI (US); Thomas J. Ludemann, Highland Village, TX (US); Trevor W. Stolber, Stillwater, MN (US); Qingbing Wang, Campbell, CA (US); Joseph D. Wheeldon, Boyceville, WI (US)

(21) Appl. No.: 16/959,710

(22) PCT Filed: Jan. 3, 2019
(86) PCT No.: PCT/IB2019/050052

§ 371 Date: Jul. 2, 2020

Related U.S. Application Data
(60) Provisional application No. 62/614,709, filed on Jan. 8, 2018.

(51) Int. Cl. G02F 1/13357; F21V 8/00

(52) U.S. Cl. CPC G02F 1/133606; G02B 6/0053; G02B 6/0051

(57) ABSTRACT

An optical film assembly comprises a light redirecting film (110) having a first structured major surface (112) and a second, opposed major surface (114). An optical adhesive layer (120) is disposed on the second major surface of the light redirecting film. A light diffusion film (140) comprises a first major surface (142) comprising a light diffusion surface and a second, opposed major surface (144). A plurality of discrete optical decoupling structures (146) project from the light diffusion surface and contact the optical adhesive layer. An air gap (148) is defined between the first major surface of the light diffusion film and the optical adhesive layer. Embodiments of optical film assemblies described herein are useful, for example, for hiding optical defects and improving the brightness uniformity of light emitted by a light source.

### CROSS REFERENCE TO RELATED APPLICATION

This application claims the benefit of U.S. Provisional Patent Application No. 62/614,709, filed Jan. 8, 2018, the disclosure of which is incorporated by reference herein in its entirety.

### BACKGROUND

Display systems, such as liquid crystal display (LCD) systems, are used in a variety of applications and commercially available devices (e.g., computer monitors, personal digital assistants (PDAs), mobile phones, miniature music players, and thin LCD televisions). Most LCDs include a liquid crystal panel and an extended area light source, often referred to as a backlight, for illuminating the liquid crystal panel. Backlights typically include at least one lamp and a number of light management films (e.g., lightguides, mirror films, light redirecting films, retarder films, light polarizing films, and diffuser films). Diffuser films are typically included to hide optical defects and improve the brightness uniformity of the light emitted by the backlight.

It is desired to have additional diffuser options to choose from for various applications.

### BRIEF SUMMARY

In one aspect, the present disclosure describes an optical film assembly comprising a light redirecting film having a first structured major surface and a second, opposed major surface. An optical adhesive layer is disposed on the second major surface of the light redirecting film. A light diffusion film comprises a first major surface comprising a light diffusion surface and a second, opposed major surface. A plurality of discrete optical decoupling structures project from the light diffusion surface and contact the optical adhesive layer. An air gap is defined between the first major surface of the light diffusion film and the optical adhesive layer.

In another aspect, the present disclosure describes an optical film assembly comprising a light redirecting film having a first structured major surface and a second, opposed major surface. An optical adhesive layer is disposed on the second major surface of the light redirecting film. A light diffusion film comprises a first major surface and a second, opposed major surface. The first major surface of the light diffusion film defines a microstructured surface comprising a light diffusion surface and a plurality of discrete optical decoupling structures. Each of the optical decoupling structures has a first end at the first major surface of the light diffusion film and a second, opposed end contacting the optical adhesive layer. An air gap is defined between the first major surface of the light diffusion film and the optical adhesive layer.

Embodiments of optical film assemblies described herein are useful, for example, for hiding optical defects and improving the brightness uniformity of light emitted by a backlight or other light source.

### BRIEF DESCRIPTION OF DRAWINGS

FIG. 1A is a side view of an illustrative optical film assembly in accordance with embodiments of the disclosure;

FIG. 1B is a perspective view of a light redirecting film shown in FIG. 1A;

FIG. 1C is a side view a portion of a light diffusion film shown in FIG. 1A according to some embodiments;

FIG. 2 shows an illustrative optical film assembly in accordance with embodiments of the disclosure;

FIG. 3 is a scanning electron microscope image (referred to herein as an SEM) of a sample light diffusion film having a patterned layer comprising a light diffusion surface and optical decoupling structures in accordance with various embodiments;

FIG. 4 is an SEM of a sample light diffusion film having a patterned layer comprising a light diffusion surface and optical decoupling structures in accordance with various embodiments;

FIGS. 5A and 5B illustrate front and side views of an optical decoupling structure in accordance with various embodiments;

FIG. 6 is a cross-sectional profile of an optical decoupling structure in accordance with various embodiments;

FIG. 7A is a cross-section of an optical decoupling structure according to some embodiments;

FIG. 7B is a cross-section of an optical decoupling structure according to some other embodiments;

FIG. 8 is a cross-section of an optical decoupling structure according to further embodiments;

FIG. 9 is a cross-section of an optical decoupling structure according to some embodiments;

FIG. 10 is a cross-section of an optical decoupling structure according to some other embodiments;

FIG. 11 is a cross-section of an optical decoupling structure according to further embodiments;

FIG. 12A is an SEM of a sample light diffusion film having a patterned layer comprising a light diffusion surface and optical decoupling structures in accordance with some embodiments;

FIG. 12B is a plan view of a sample light diffusion film having a patterned layer comprising a light diffusion surface and optical decoupling structures in accordance with some other embodiments;

FIG. 13 is a graph showing ranges of optical decoupling structure height for different densities, D, of the optical decoupling structures according to various embodiments;

FIG. 14 is a graph showing ranges of optical decoupling structure length for different densities, D, of the optical decoupling structures according to various embodiments; and

FIG. 15 is an SEM of a sample optical film assembly comprising a light redirecting film and a light diffusing film in accordance with various embodiments.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION OF ILLUSTRATIVE EMBODIMENTS

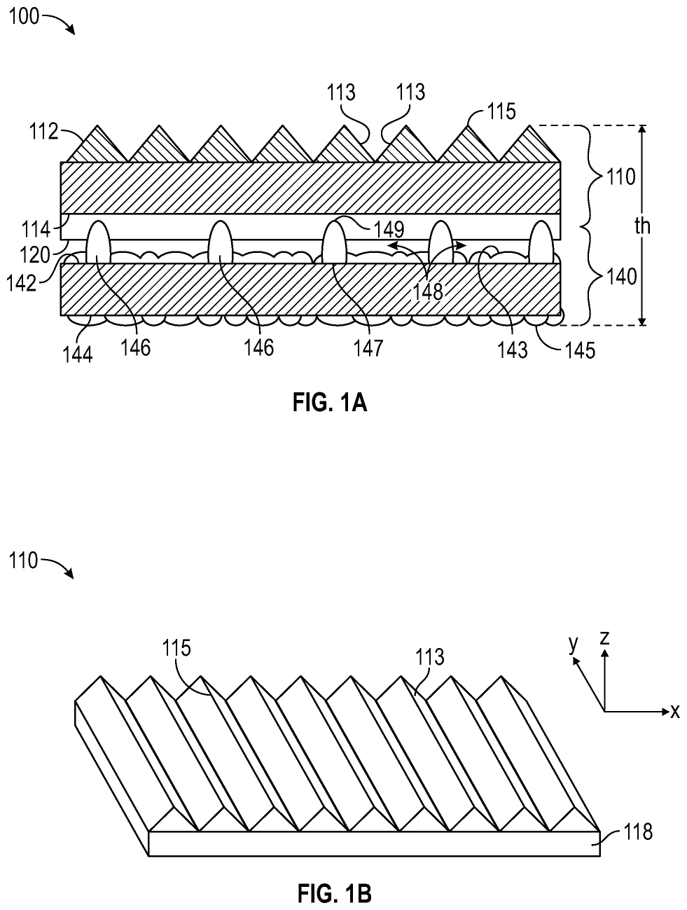

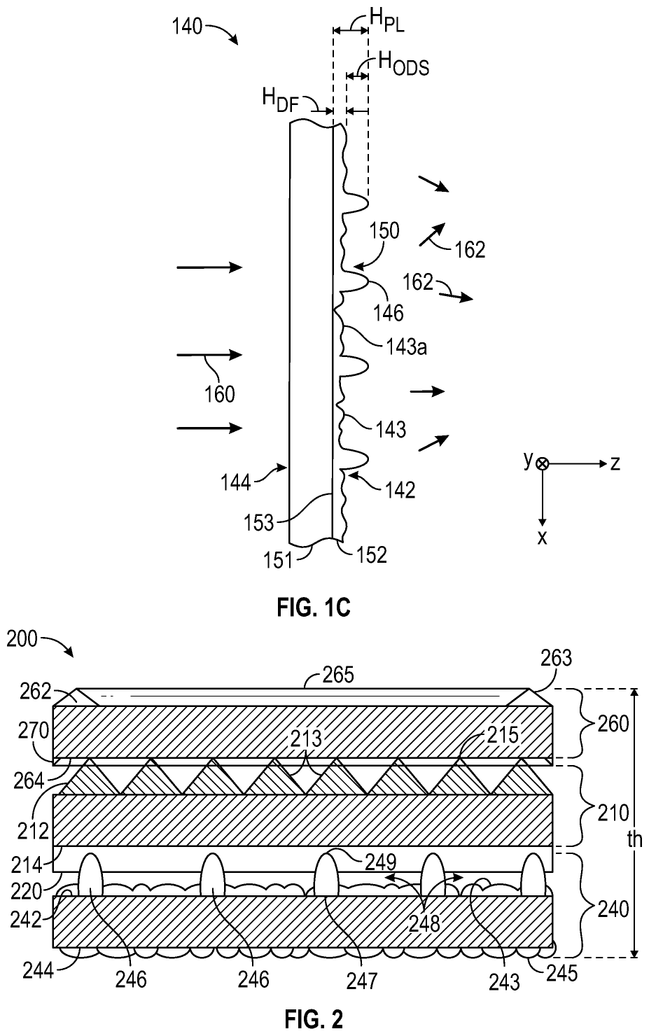

FIG. 1A shows illustrative optical film assembly in accordance with embodiments of the disclosure 100. Optical film assembly 100 includes light redirecting film 110 having first structured major surface 112 and second, opposed major surface 114. First structured major surface 112 comprises optically effective microstructures (e.g., as shown linear prisms 113 with peaks 115). FIG. 1B is a perspective view of light redirecting film 110 shown in FIG. 1A. Light redirecting film 110 includes plurality of linear prisms 113 with peaks 115 (extending along the y-direction) formed on body layer 118. Optical adhesive layer 120 is disposed on second major surface 114 of light redirecting film 110.

Optical film assembly 100 also includes light diffusion film 140 having first major surface 142 and second, opposed major surface 144. First major surface 142 of light diffusion film 140 is oriented toward second major surface 114 of light redirecting film 110. In some embodiments, first major surface 142 comprises structured light diffusion surface 143 and second major surface 144 comprises structured light diffusion surface 145. In some other embodiments, first major surface 142 comprises light diffusion surface 143 and second major surface 144 is devoid of a light diffusion surface.

Light diffusion film 140 comprises plurality of discrete optical decoupling structures 146 projecting from first major surface 142 of light diffusion film 140. Each of optical decoupling structures 146 has first end 147 at first major surface 142 of light diffusion film 140 and second end 149 contacting optical adhesive layer 120 disposed on second major surface 114 of light redirecting film 110. Second ends 149 of optical decoupling structures 146 extend into and adhere to optical adhesive layer 120. In some embodiments, second ends 149 of optical decoupling structures 146 penetrate through only a portion of optical adhesive layer 120 and do not contact second major surface 114 of light redirecting film 110. In some other embodiments, second ends 149 of optical decoupling structures 146 penetrate through optical adhesive layer 114 and contact second major surface 114 of light redirecting film 110.

Air gap 148 is defined between first major surface 142 of light diffusion film 140 and optical adhesive layer 120 disposed on second major surface 114 of light redirecting film 110. Air gap 148 has a height (along the z-axis) in a range from 0.5 to 1.5 (in some embodiments, in a range from 0.8 to 1.2, or 0.9 to 1.1, or even 0.9 to 1) micrometers. Air gap 148 between light redirecting film 110 and light diffusion film 140 optimizes optical performance of optical film assembly 100. Provision of air gap 148 between light redirecting film 110 and light diffusion film 140 facilitates light traveling at angles larger than the total internal reflection angles (TIR angles) to be trapped within each film 110, 140. Such a configuration is sometimes referred to as “optically decoupled,” which provides desired optical performance. In some optical film assemblies, the gap between two optical films is filled by a third optical material, for example an optically clear adhesive, in which case the desired total internal reflection interfaces of the optical films are compromised. In such assemblies, light at high angles will travel from one optical film to another, thereby degrading resultant optical performance. The two optical films in this scenario are sometimes referred to as being “optically coupled.”

In some embodiments, optical film assembly 100 can have a thickness, th, of less than 300 (in some embodiments, less than 200, 100, or even less than 80; in some embodiments, in a range from 40 to 500, 50 to 200, or even 50 to 100) micrometers.

The components shown in FIG. 1A define unitary optical film assembly 100 in which light redirecting film 110 and light diffusion film 140 are physically coupled in a mechanically robust configuration while minimizing the degree to which they are optically coupled. Provision of optical decoupling structures 146 on first major surface 142 of light diffusion film 140 provides several advantages, including a reduction in the number of fabrication processing steps, a reduction in materials and fabrication cost, the elimination of various components (e.g., an ultra-low index layer or a sealing layer) required in some conventional optical film assemblies, a reduction in the number of loose films in a display system, and a reduction in film dimensions and tolerance to enable a narrower backlight and display bezel. For example, the unitary construction of optical film assembly 100 allows greater precision when die-cutting parts from stock film and eliminates the use of black tape on the edge to ensure alignment of a film stack, which allows the display bezel to be narrower.

FIG. 2 shows illustrative optical film assembly in accordance with embodiments of the disclosure 200. Optical film assembly 200 is same optical film assembly 100 shown in FIG. 1A except that optical film assembly 200 includes light redirecting films 210 and 260. Optical film assembly 200 includes first light redirecting film 210 and second light redirecting film 260. First light redirecting film 210 has first structured major surface 212 and second, opposed major surface 214. First structured major surface 212 comprises optically effective microstructures (e.g., as shown linear prisms 213 with peaks 215). Linear prisms 213 of first light redirecting film 210 extend along the y-direction. Second light redirecting film 260 has first structured major surface 262 and second, opposed major surface 264. First structured major surface 262 comprises optically effective microstructures (e.g., as shown linear prisms 263 with peaks 265). Linear prisms 263 of second light redirecting film 260 extend along the z-direction. Linear prisms 263 of second light redirecting film 260 are oriented orthogonal to linear prisms 213 of light redirecting film 210. Second major surface 264 includes optical adhesive layer 270 into which peaks 215 of linear prisms 213 on first structured major surface 212 of first light redirecting film 210 penetrate. Optical adhesive layer 270 bonds second light redirecting film 260 to first light redirecting film 210. Prismatic films 210 and 260 may collectively comprise what is referred to as a “crossed prismatic film.”

Optical film assembly 200 also includes light diffusion film 240 having first major surface 242 and second, opposed major surface 244. First major surface 242 of light diffusion film 240 is oriented toward second major surface 214 of light redirecting film 210. In some embodiments, first major surface 242 comprises light diffusion surface 243 and second major surface 244 comprises light diffusion surface 245. In some other embodiments, first major surface 242 comprises light diffusion surface 243 and second major surface 244 is devoid of light diffusion surface.

Light diffusion film 240 comprises plurality of discrete optical decoupling structures 246 projecting from first major surface 242 of light diffusion film 240. Each of optical decoupling structures 246 has first end 247 at first major surface 242 of light diffusion film 240 and second end 249 contacting optical adhesive layer 220 disposed on second major surface 214 of light redirecting film 210. Second ends 249 of optical decoupling structures 246 extend into and adhere to optical adhesive layer 220. In some embodiments, second ends 242 of optical decoupling structures 246 penetrate through only a portion of optical adhesive layer 220 and do not contact second major surface 214 of light redirecting film 210. In some other embodiments, second ends 242 of optical decoupling structures 246 penetrate through optical adhesive layer 220 and contact second major surface 214 of light redirecting film 210. Air gap 248 is defined between first major surface 242 of light diffusion film 240 and optical adhesive layer 220 disposed on second major surface 214 of light redirecting film 210. As discussed above, air gap 248 between light redirecting film 210 and light diffusion film 242 optimizes optical performance of optical film assembly 200.

In some embodiments, optical film assembly 200 can have a thickness, th, of less than 500 (in some embodiments, less than 400, 300, 200, or even less than 100; in some embodiments, in a range from 50 to 500, 50 to 200, or even 100 to 150) micrometers.

Referring again to FIG. 1A, light redirecting film 110 of optical film assembly 100 includes plurality of microstructures 113 configured to impart desired light management properties to optical film assembly 100. As used herein, the term “light” refers to energy at at least one wavelength in the electromagnetic spectrum. Non-limiting examples of “light” include solar energy, infrared (IR) light, visible light, or ultraviolet (UV) light. Solar energy may include at least one of IR light, visible light, or UV light. Microstructures 113 can be an array of linear microprisms (e.g., such films often being referred to as “prismatic film”) or other lenticular features. Microstructures 113 can be of selected geometry to impart desired light management properties to optical film assembly 100. Those skilled in the art will be able to readily select a suitable light redirecting film 110 with appropriate configurations, to provide desired optical performance.

Microstructures 113 may be any total internal reflection promoting replicated surface structures including prisms and/or lenticulars. Microstructures 113 can be continuous or piecewise continuous. The dimensions of microstructures 113 may be uniform or irregular. Although linear microstructures 113 are shown in FIG. 1A and other figures, in-plane serpentine variations and/or variations in height along the peaks or from peak to peak of the linear microstructures may be imposed. In some embodiments, microstructures 113 define a linear array of regular right prisms, which can provide both optical performance and ease of manufacture. By right prisms, it is meant that the apex angle θ is about 90°, but can also range from about 50° to 150° (in some embodiments from about 80° to 100°). The prism facets need not be identical, and the prisms may be tilted with respect to each other. The prisms can also have rounded prism apexes or flat prism apexes.

Light redirecting film 110 can be manufactured from suitable optically effective materials. Typically, polymeric materials such as acrylic, polycarbonate, or UV-cured acrylate are used. Light redirecting film 110 may be of monolayer or multilayer construction. In the case of a multilayer assembly, the constituent layers are made of such materials, with different constituent layers in an assembly being made with the same or different materials. For example, FIG. 1B can represent a multilayer embodiment of light redirecting film 110 shown in FIG. 1A comprising structured layer 113 made of cast and cured materials (e.g., ultraviolet-cured acrylics) cast on polyester body layer 118 (e.g., polyester terephthalate (“PET”)) as a substrate. Biaxially oriented PET is often preferred for its mechanical and optical properties.

Illustrative examples of light redirecting films which may be used in optical film assemblies of the disclosure include a light redirecting film (available, for example, under the trade designation “TBEF-DT” from 3M Company, St. Paul, Minn.) and a light redirecting film (available, for example, under the trade designation “TBEF2-DT” from 3M Company). Illustrative examples of light redirecting films which may be used in optical film assemblies of the disclosure are disclosed in U.S. Pat. No. 9,116,285 (Edmonds et al.) and U.S. Pat. No. 9,229,141 (Boyd), both of which are incorporated herein by reference. Other alternatives will be readily apparent to those skilled in the art.

As is illustrated in FIG. 1A, optical adhesive layer 120 is disposed on second major surface 114 of light redirecting film 110. Second ends 149 of optical decoupling structures 146 penetrate into, and are bonded to, optical adhesive layer 120. Optical adhesive layer 120 is preferably an optically clear adhesive. An optically clear adhesive refers to an adhesive that has a high light transmittance over at least a portion of the visible light spectrum (about 400 to about 700 nm), and that exhibits low haze. An optically clear adhesive can have a luminous transmission of at least about 90 percent and a haze of less than about 2 percent in the 400 to 700 nm wavelength range. Optical adhesive layer 120 can have a thickness of less than 20 (in some embodiments, less than 15, 10, or even less than 2; in some embodiments, in a range from 1 to 20, 1 to 10, or even 1 to 5) micrometers.

Exemplary optical adhesives that can form optical adhesive layer 120 include pressure sensitive adhesives (PSAs), heat-sensitive adhesives, solvent-volatile adhesives, and UV-curable adhesives. Exemplary PSAs include those based on natural rubbers, synthetic rubbers, styrene block copolymers, (meth)acrylic block copolymers, polyvinyl ethers, polyolefins, and poly(meth)acrylates. As used herein, (meth)acrylic (or acrylate) refers to both acrylic and methacrylic species. Other exemplary PSAs include (meth)acrylates, rubbers, thermoplastic elastomers, silicones, urethanes, and combinations thereof. In some cases, the PSA is based on a (meth)acrylic PSA or at least one poly(meth)acrylate. Exemplary silicone PSAs include a polymer or gum and an optional tackifying resin. Other exemplary silicone PSAs include a polydiorganosiloxane polyoxamide and an optional tackifier.

In some embodiments, optical adhesive layer 120 can be or include a structural adhesive. Generally, useful structural adhesives contain reactive materials that cure to form a strong adhesive bond. The structural adhesive may cure spontaneously upon mixing (such as a 2-part epoxy adhesive) or upon exposure to air (e.g., a cyanoacrylate adhesive) or curing may be affected by the application of heat or radiation (e.g., UV light). Examples of suitable structural adhesives include epoxies, acrylates, cyanoacrylates, and urethanes.

According to other embodiments, the optical adhesive forming optical adhesive layer 120 is any polyacrylate adhesive that is curable or cross-linkable or that can be combined with a cross-linking material to create a structural adhesive. In one embodiment, the adhesive includes about 35 wt. % to about 75 wt. % polyacrylate. In another embodiment, the polyacrylate is a pressure sensitive adhesive. In a further embodiment, the polyacrylate includes monomeric repeat units being branched C4-C12 alkyl groups (e.g., as isooctyl). In one embodiment, the polyacrylate includes repeat units derived from acrylic acid. In another embodiment, the polymerizable monomer is an epoxy component and the adhesive composition further includes a photoactivated cationic initiator. In a further embodiment, the polymerizable monomer includes at least three (meth)acrylate groups and the adhesive composition further includes a free-radical photoinitiator.

FIG. 1C is a side view of a portion of light diffusion film 140 shown in FIG. 1A according to some embodiments. Light diffusion film 140 is shown to have first major surface 142 and second major surface 144. Incident light 160 is shown impinging on the light diffusion film 140 at second major surface 144. Light 160 passes through light diffusion film 140, and is scattered or diffused as a result of refraction (and to some extent diffraction) at the roughened or structured topography of first major surface 142, producing scattered or diffuse light 162.

First major surface 142 defines structured surface 150 comprising light diffusion surface 143 and optical decoupling structures 146. In some embodiments, light diffusion surface 143 and optical decoupling structures 146 have the same material composition (i.e., comprise the same material). For example, light diffusion surface 143 and optical decoupling structures 146 comprise a light transmissive polymer, such as acrylate or an epoxy resin. By way further example, the light diffusion surface 143 and optical decoupling structures 146 comprise at least one of polyacrylate, polymethacrylate, polycarbonate, polyethylene terephthalate, polyethylene naphthalate, polystyrene, cyclic olefin polymers, or co-polymer thereof (including combinations thereof). However, other polymer materials, as well as non-polymer materials, may also be used. Second major surface 144 can include or be devoid of a light diffusion surface. For example, second major surface 144 shown in FIG. 1C is devoid of a light diffusion surface, while second major surface 144 shown in FIG. 1A includes light diffusion surface 145.

In FIG. 1C, light diffusion film 140 is shown as having a 2-layer construction comprising substrate 151 that carries patterned layer 152. Structured surface 150 is preferably imparted to patterned layer 152 by microreplication from a structured surface tool, as explained further below. Substrate 151 may for example be a carrier film on which patterned layer 152 has been cast and cured. Curing of the material used to form patterned layer 152 can be carried out with ultraviolet (UV) radiation, with heat, or in any other known way. As an alternative to casting-and-curing, the structured surface 150 may be imparted from the tool to patterned layer 152 by embossing a thermoplastic material with sufficient heat and pressure.

Light diffusion film 140 need not have the 2-layer construction of FIG. 1C, but may instead include more than 2 layers, or it may be unitary in construction, composed of only a single layer. Typically, the layer(s) that make up light diffusion film 140 is highly transmissive to light, at least to light over a majority of the visible spectrum. Such layer(s) thus typically has a low absorption for such light.

Exemplary materials for use as substrate 151 include light-transmissive polymers (e.g., polyacrylates and polymethacrylates, polycarbonate, polyethylene terephthalate, polyethylene naphthalate, polystyrene, cyclo olefin polymers, and co-polymers or combinations of these polymer classes). Exemplary materials for use as patterned layer 152 include light transmissive polymers (e.g., acrylate and epoxy resins). Other polymer materials, however, as well as non-polymer materials, may also be used. The layer(s) of light diffusion film 140 may have any suitable index of refraction (e.g., in a range from 1.4 to 1.8 (in some embodiments, in a range from 1.5 to 1.8, or even 1.5 to 1.7)). The index of refraction may be specified at 550 nm, or at another suitable design wavelength, or it may be an average over the visible wavelength range.

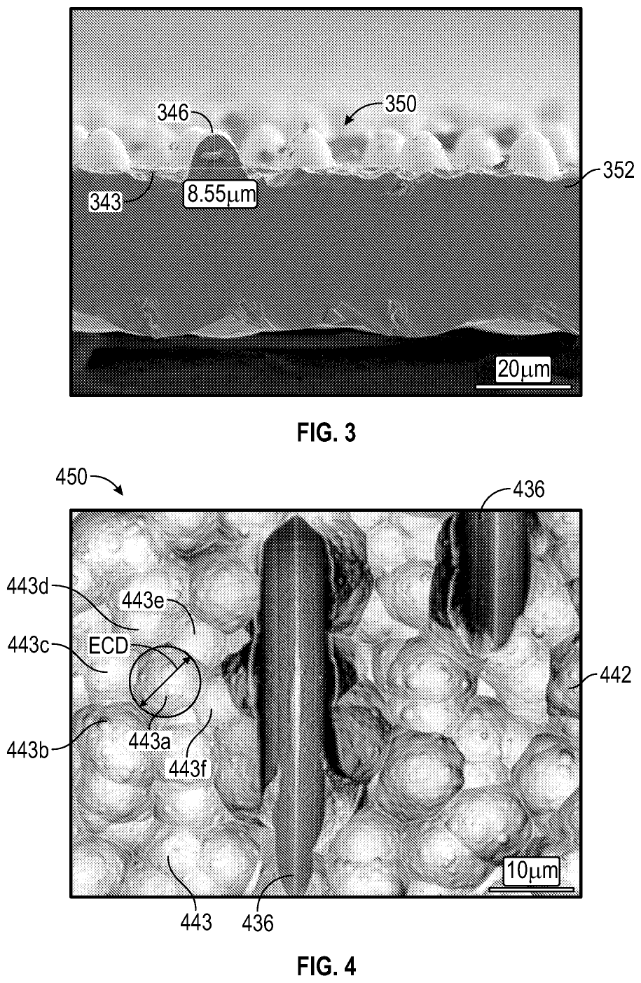

First major surface 142 of light diffusion film 140 extends generally along orthogonal in-plane directions, which can be used to define a local Cartesian x-y-z coordinate system. The topography of light diffusion surface 143 can then be expressed in terms of deviations along a height direction (z-axis), relative to a reference plane (the x-y plane) lying parallel to light diffusion surface 143. Light diffusion surface 143 has a mean height, H_{DF}, relative to surface 153 of substrate 151 of less than 5 (in some embodiments, less than 4, or even less than 3; in some embodiments, in a range from 2 to 5) micrometers, for example. Optical decoupling structures 146 have a height, H_{ODS}, relative to the mean height, H_{DF}, of light diffusion surface 143 of less than 8 (in some embodiments, less than 7, or 6, or even less than 5; in some embodiments, in a range from 4 to 6) micrometers. Patterned layer 152 comprising light diffusion surface 143 and optical decoupling structures 146 has a height, H_{PL}, of less than 10 (in some embodiments, less than 9, or even less than 8; in some embodiments, in a range from 7 to 9) micrometers. For example, FIG. 3 is an SEM of a sample light diffusion film having patterned layer 352 on a substrate. Patterned layer 352 comprises light diffusion surface 343 and optical decoupling structures 346 projecting from light diffusion surface 343. Patterned layer 352 has a height, H_{PL}, of 8.55 micrometers in this illustrative example.

In some embodiments, second major surface 144 of light diffusion film 140 can include a light diffusion surface (e.g., such as light diffusion surface 145 shown in FIG. 1A). Light diffusion surface 145 on second major surface 144 can have the same or different structure as light diffusion surface 143 on first major surface 142. As is discussed in greater detail below, the total haze and clarity of light diffusion film 140 as a whole is a combination of the individual hazes and clarities respectively associated with first and second major surfaces 142, 144. First major surface 142 and optionally second major surface 144 preferably have physical properties that avoid or diminish one or more artifacts (e.g., moire, sparkle, graininess, and other observable spatial patterns or marks).

FIG. 4 illustrates a portion of first major surface 442 of a light diffusion film comprising structured surface 450 in accordance with various embodiments. Structured surface 450 includes light diffusion surface 443 and optical decoupling structures 436. Light diffusion surface 443 and optical decoupling structures 436 are integral features of structured surface 450. For example, light diffusion surface 443 and optical decoupling structures 436 have the same material composition.

In many cases, the topography of light diffusion surface 443 is such that distinct individual structures can be identified (e.g., structures 443a, 443b, 443c, 443d, 443e, and 443f). Such structures may be in the form of protrusions, which are made from corresponding cavities in a structured surface tool used to produce structured first major surface 442, or cavities, which are made from corresponding protrusions in the structured surface tool. Whether protrusions or cavities, the structures of light diffusion surface 443 may also in some cases be closely packed (i.e., arranged such that at least portions of boundaries of many or most adjacent structures substantially meet or coincide). The structures are also typically irregularly or non-uniformly dispersed on light diffusion surface 443. In some cases, the structures may have a bimodal distribution of larger structures in combination with smaller structures. In some cases, some, most, or substantially all (e.g., >90% (in some embodiments, >95%, or even >99%)) of the structures may be curved or comprise a rounded or otherwise curved base surface. In some cases, at least some of the structures may be pyramidal in shape or otherwise defined by substantially flat facets.

As is shown in FIG. 4, the size of a given structure (e.g., structure 443a) may be expressed in terms of an equivalent circular diameter (ECD) in-plan view, and the structures of light diffusion surface 443 may have an average ECD of less than 15 (in some embodiments, less than 10; in some embodiments, in a range from 4 to 10) micrometers, for example. The structures of light diffusion surface 443 can in at least some cases be characterized by an aspect ratio of the depth or height of the structures divided by a characteristic transverse dimension (e.g., the ECD) of the structures. The structured surface may comprise ridges, which may for example be formed at the junctions of adjacent closely-packed structures. In such cases, a plan view of the structured surface (or of a representative portion thereof) may be characterized in terms of the total ridge length per unit area. Light diffusion surface 443 may be characterized by a total ridge length per unit area in-plan view of less than 200 (in some embodiments, less than 150; in some embodiments, in a range from 10 to 150) mm/mm². Additional details for characterizing structures of light diffusion surface 443 in terms of ECD and total ridge length per unit area are disclosed in U.S. Pat. Pub. No. 2015/0293272 A1 (Pham et al.), which is incorporated herein by reference.

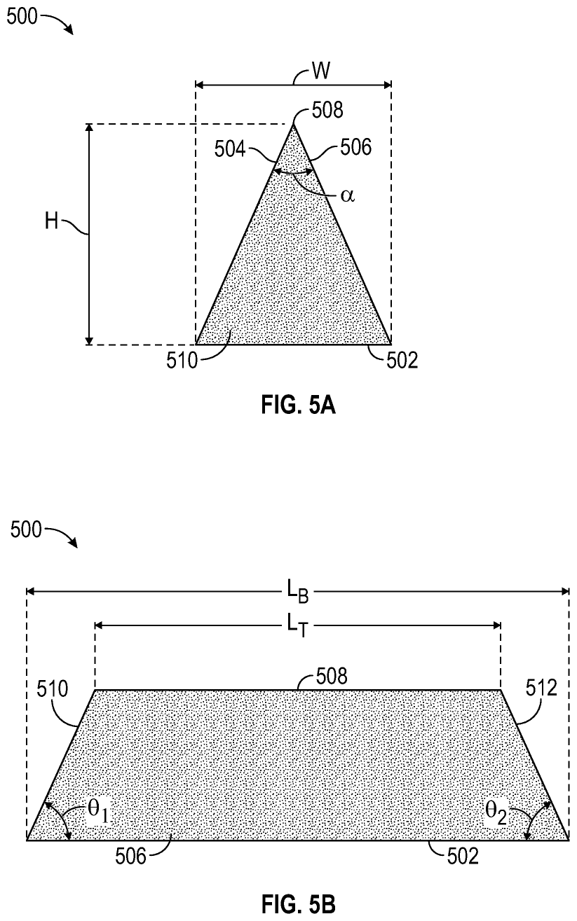

Optical decoupling structures 436 shown in FIG. 4 can have dimensions consistent with those discussed with reference to FIGS. 5A and 5B. FIGS. 5A and 5B illustrate front and side views of optical decoupling structure 500 in accordance with various embodiments. Optical decoupling structure 500 includes base 502, top surface 508, first side surface 504, second side surface 506, first end surface 510, and second end surface 512. Base 502 can have a width, W, for example, in a range from 4 to 20 (in some embodiments, in a range from 4 to 10, or even 6 to 8) micrometers.

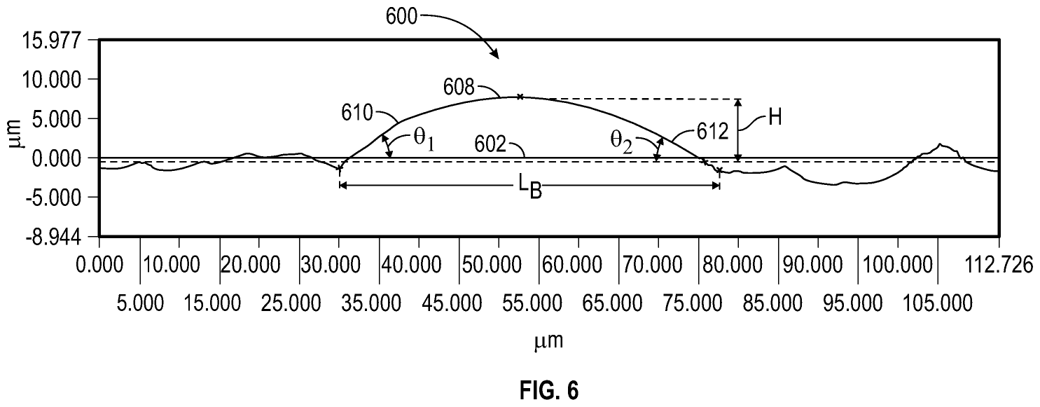

In various embodiments, base 502 has a length L_{B} that can range, for example, from 4 to 100 (in some embodiments, in a range from 10 to 70, 20 to 50, or even 30 to 40) micrometers. In various embodiments, top surface 508 has a length L_{T} that can range from, for example, 0 to 60 (in some embodiments, in a range from 10 to 50, or even 20 to 40) micrometers. In some embodiments, top surface 508 is planar. In some other embodiments, top surface 508 is curved. In further embodiments, first end surface 510, top surface 508, and second end surface 512 define a continuous curved surface (see, e.g., FIG. 6).

Optical decoupling structure 500 has a height H defined between base 502 and top surface 508. As was discussed previously, the structured surface of a light diffusion film includes a light diffusion surface and optical decoupling structures projecting from the light diffusion surface. The height H of optical decoupling structure 500 represents the height of optical decoupling structure 500 above the mean height, H_{DF}, of the light diffusion surface. According to various embodiments, the height H can range from 3 to 20 (in some embodiments, in a range from 3 to 10, 4 to 8, or even 5 to 6) micrometers.

An angle α is defined between first side surface 504 and second side surface 506 extending from top surface 508. In some embodiments, the angle α can range from 3 to 40 (in other embodiments, in a range from 20 to 40, or even 30 to 40) degrees. An angle θ₁ is defined between first end surface 510 and base 502. An angle θ₂ is defined between second end surface 512 and base 502. In various embodiments, angles θ₁ and θ₂ can independently range from 20 to 40 (in some embodiments, in a range from 30 to 40) degrees. In various embodiments, the angle θ₁ can differ from the angle θ₂ by 3 to 10 (in some embodiments, the angle θ₁ can differ from the angle θ₂ by 4 to 7) degrees.

FIG. 6 is a cross-sectional profile of an optical decoupling structure in accordance with various embodiments. In FIG. 6, optical decoupling structure 600 has a rounded canoe shape. Optical decoupling structure 600 includes base 602, top surface 608, first end surface 610, and second end surface 612. Top surface 608 is a continuously curved surface extending between opposing ends of base 602. Height H defined between base 602 and top surface 608 can range from 4 to 6 micrometers above a mean height, H_{DF}, of the light diffusion surface (shown as a dotted line). Angle θ₁ defined between first end surface 610 and base 602 can range from 35 to 40 (in some embodiments, in a range from 36 to 38) degrees. Angle θ₂ defined between the second end surface 612 and base 602 can range from 30 to 35 (in some embodiments, in a range from 30 to 32) degrees.

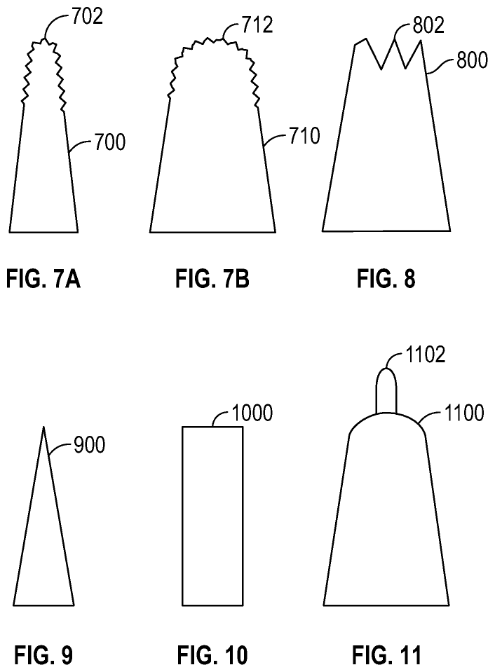

The optical decoupling structures can have any useful cross-section. In some embodiments, as shown in FIG. 7A, a cross-section of optical decoupling structure 700 in a direction perpendicular to a length of the optical decoupling structure has a narrow U-shape (see also optical decoupling structure 146 shown in FIG. 1A). The tip region of optical decoupling structure 700 can include optional structures 702 (e.g., less than 1 micrometer in height) that increase the contact area between optical decoupling structure 700 and an optical adhesive layer. In other embodiments, as shown in FIG. 7B, a cross-section of optical decoupling structure 710 in a direction perpendicular to a length of optical decoupling structure 710 has a wide U-shape. A tip region of optical decoupling structure 710 can include optional structures 712 (e.g., less than 1 micrometer in height) that increase the contact area between optical decoupling structure 710 and an optical adhesive layer. In some other embodiments, as shown in FIG. 8, a cross-section of optical decoupling structure 800 in a direction perpendicular to a length of optical decoupling structure 800 has a trapezoidal shape. A tip region of optical decoupling structure 800 can include optional structures 802 (greater than 1 micrometer in height) that increase the contact area between optical decoupling structure 800 and an optical adhesive layer. In further embodiments, as shown in FIG. 9, a cross-section of optical decoupling structure 900 in a direction perpendicular to a length of optical decoupling structure 900 has a narrow V-shape. As is shown in FIG. 5A, a cross-section of optical decoupling structure 500 in a direction perpendicular to a length of optical decoupling structure 500 has a wide V-shape. In some embodiments, as shown in FIG. 10, a cross-section of optical decoupling structure 1000 in a direction perpendicular to a length of optical decoupling structure 1000 has a rectangular shape. In other embodiments, as shown in FIG. 11, a cross-section of optical decoupling structure 1100 in a direction perpendicular to a length of optical decoupling structure 1100 has a wide U-shape. The optical decoupling structure 1100 has a tip region comprising projection 1102. A cross-section of projection 1102 in a direction perpendicular to a length of optical decoupling structure 1100 has a narrow U-shape.

Among the various parameters that can be used to characterize the optical behavior of a given optical diffusing film, two key parameters are optical haze and optical clarity. Light diffusion or scattering can be expressed in terms of optical haze, or simply haze. For a film, surface, or other object that is illuminated by a normally incident light beam, the optical haze of the object refers to the ratio of transmitted light that deviates from the normal direction by more than 4 degrees to the total transmitted light as measured using a haze meter (available under the trade designation “HAZE-GARD PLUS” from BYK-Gardner, Columbia, Md.). To measure the haze of light diffusion film 140 shown in FIG. 1A, film 140 was positioned at the haze port of the haze meter (“HAZE-GARD PLUS”) with second major surface 144 oriented toward the light source. The operate switch was depressed and haze measurement results were displayed and recorded. Related to optical haze is optical clarity, which is also measured using a haze meter (“HAZE-GARD PLUS”), but where the instrument is fitted with a dual sensor having a circular middle sensor centered within an annular ring sensor. Optical clarity refers to the ratio (T1−T2)/(T1+T2), where T1 is the transmitted light sensed by the middle sensor and T2 is the transmitted light sensed by the ring sensor, the middle sensor subtending angles from zero to 0.7 degree relative to an axis normal to the sample and centered on the tested portion of the sample, and the ring sensor subtending angles from 1.6 to 2 degrees relative to such axis, and where the incident light beam, with no sample present, overfills the middle sensor but does not illuminate the ring sensor (underfills the ring sensor by a half angle of 0.2 degree). To measure the clarity of light diffusion film 140 shown in FIG. 1A, film 140 was positioned at the clarity port of the haze meter (“HAZE-GARD PLUS”) with second major surface 144 oriented toward the light source. The operate switch was depressed and clarity measurement results were displayed and recorded.

Referring again to FIG. 1A, first and second major surfaces 142, 144 include light diffusion surfaces 143, 145. In some embodiments, only first major surface 142 includes light diffusion surface 143, and second major surface 144 is devoid of a light diffusion surface. The total haze and clarity of light diffusion film 140 as a whole (with optical decoupling structures 146) is a combination of the individual hazes and clarities respectively associated with first and second major surfaces 142, 144. In some embodiments, the total optical haze of light diffusion film 140 is in a range from 50 to 100 (in some embodiments, in a range from 80 to 100, 85 to 95, or even 90 to 95) %. For example, light diffusion film 140 can provide a total haze of at least 90 (in some embodiments, at least 91, 92, 93, 94, 95, 96, 97, 98, or even at least 99; in some embodiments, in a range from 50 to 100, 70 to 95, or even 80 to 90) %. In some embodiments, the optical haze of second major surface 144 is in a range from 0 to 100 (in some embodiments, in a range from 20 to 80, 40 to 60) %. In some embodiments, the total clarity of light diffusion film 140 is less than 15 (in some embodiments, less than 10; in some embodiments, in a range from 0 to 50) %.

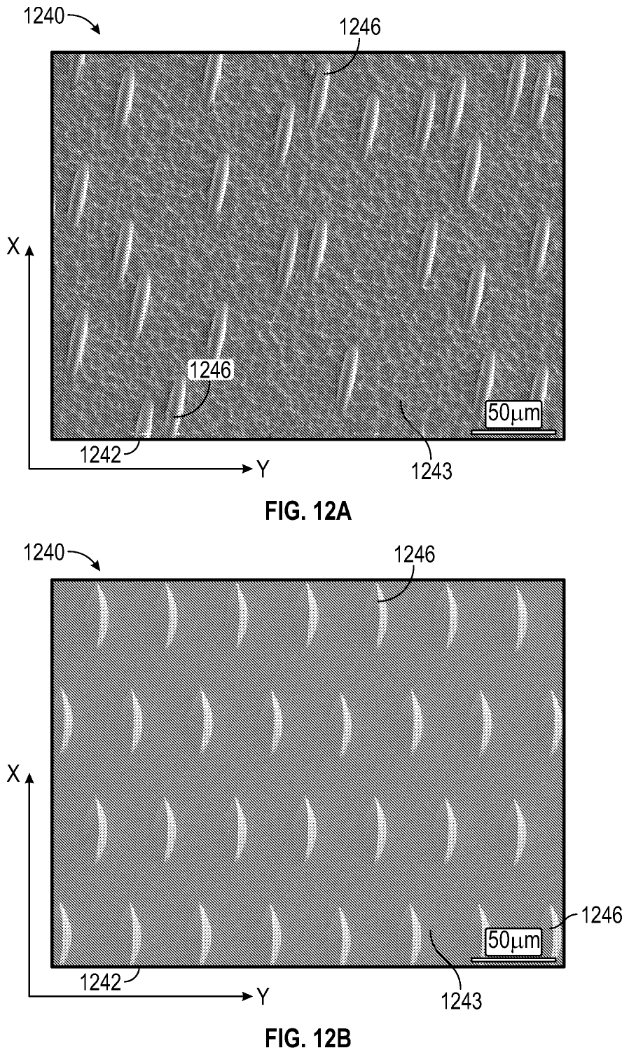

According to various embodiments, optical decoupling structures can be arranged on the surface of a light diffusion film to achieve desired coverage criteria. With reference to the SEM shown in FIG. 12, first major surface 1242 of light diffusion film 1240 includes light diffusion surface 1243 and multiplicity of optical decoupling structures 1246. First major surface 1242 has a total surface area given by A in, for example, micrometer². The total area of first major surface 1242 covered by the optical decoupling structures 1246 is given by a in, for example, micrometer². The percent coverage of first major surface 1242 by optical decoupling structures 1246 is given by the ratio a/A (%). In various embodiments, optical decoupling structures 1246 covers less than 20 (in some embodiments, less than 15, 10, or even less than 5; in some embodiments, in a range from 3 to 50, 5 to 20, or even 5 to 10) % by area of first major surface 1242.

According to various embodiments, the optical decoupling structures 1246 can be arranged on first major surface 1242 of light diffusion film 1240 to achieve desired density criteria. The density, D, of optical decoupling structures 1246 (features) can be defined in terms of number of optical decoupling structures 1246 per square millimeter (features/mm²). According to various embodiments, the density, D, of optical decoupling structures 1246 can be in a range from 50 to 1500 (in some embodiments, in a range from 50 to 500, 50 to 300, 50 to 150, or even 50 to 100) features/mm².

In accordance with various embodiments, optical decoupling structures 1246 can cover in a range from 5 to 15% (e.g., 10%) by area of first major surface 1242, and the density, D, can be in a range from 250 to 350 features/mm² (e.g., 300 features/mm²). In some other embodiments, optical decoupling structures 1246 can cover in a range from 5 to 10% (e.g., 6%) by area of first major surface 1242, and the density, D, can be in a range from 100 to 200 features/mm² (e.g., 150 features/mm²).

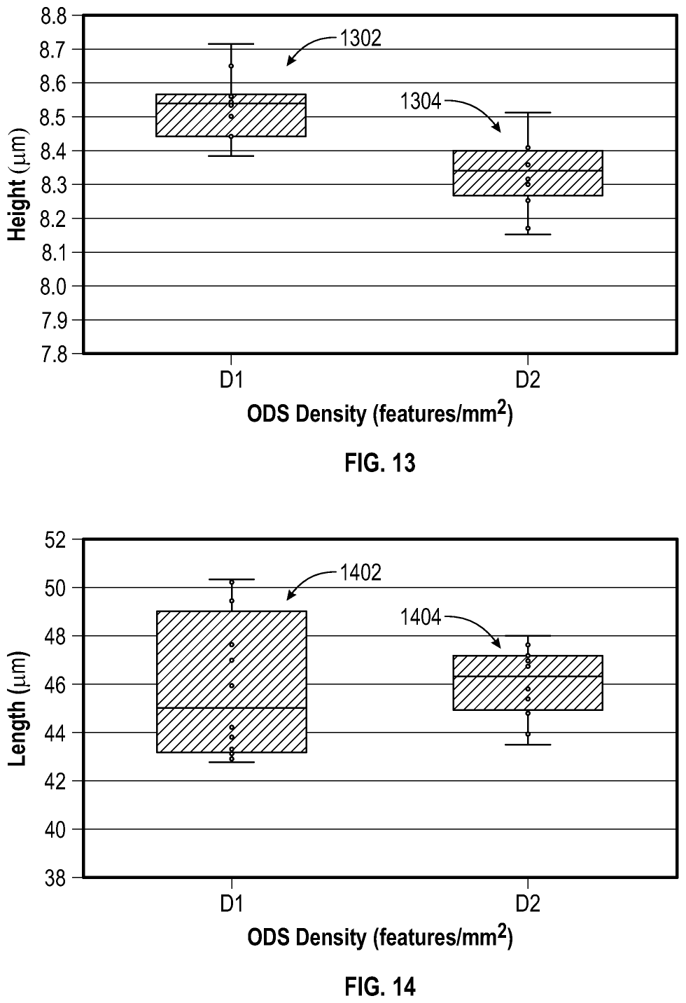

The height of the optical decoupling structures can be related to the density, D, of the optical decoupling structures. For example, the height of the optical decoupling structures can be different for different densities, D, of the optical decoupling structures. FIG. 13 shows first range 1302 of heights associated with a first density, D1, of optical decoupling structures. FIG. 13 also shows second range 1304 of heights associated with a second density, D2, of optical decoupling structures. The heights shown in FIG. 13 represent heights of the optical decoupling structures measured relative to the mean height, H_{DF}, of the light diffusion surface from which the optical decoupling structures project. In FIG. 13, the first density, D1, is greater than the second density, D2. For example, the first density, D1, can be 300 features/mm², and the second density, D2, can be 150 features/mm².

The length of the optical decoupling structures can be related to the density, D, of the optical decoupling structures. For example, the length of the optical decoupling structures can be different for different densities, D, of the optical decoupling structures. FIG. 14 shows first range 1404 of lengths associated with a first density, D1, of optical decoupling structures. FIG. 14 also shows second range 1404 of lengths associated with a second density, D2, of optical decoupling structures. The lengths shown in FIG. 14 represent the longest part of an optical decoupling structure that can be visually evaluated using an appropriate instrument. In FIG. 14, the first density, D1, is greater than the second density, D2. For example, the first density, D1, can be 300 features/mm², and the second density, D2, can be 150 feature s/mm².

According to various embodiments, optical decoupling structures can be arranged on the surface of a light diffusion film to achieve desired distribution criteria. In some embodiments, as is shown in FIG. 12A, optical decoupling structures 1246 can be positioned on first major surface 1242 of light diffusion film 1240 in randomized patterns in both X and Y directions. In other embodiments, optical decoupling structures 1246 can be positioned on first major surface 1242 with a randomized pattern in one direction (e.g., X direction) and a uniform (e.g., periodic) pattern in a second direction (e.g., Y direction). Optical decoupling structures 1246 can be linear along the X direction or the Y direction.

In some embodiments, optical decoupling structures are distributed uniformly across the first major surface of the light diffusion film, as is shown in FIG. 1A, for example. By way of further example, and with reference to FIG. 12B, optical decoupling structures 1246 can be uniform (e.g., periodic) in both the X and Y directions. In some embodiments, optical decoupling structures 1246 of adjacent rows or columns can be offset from one another, as is shown in FIG. 12B. It is understood that the positioning, orientation, and size of optical decoupling structures 1246 can vary from those shown in the figures.

In other embodiments, the optical decoupling structures are distributed uniformly across the first major surface of the light diffusion film but aligned randomly relative to one another, as is shown in FIG. 12A. For example, assuming light diffusion film 1240 shown in FIG. 12A is divided into quadrants, each quadrant would have about the same number of optical decoupling structures 1246. The relative alignment between optical decoupling structures 1246 in each quadrant, however, can be random. The distribution of optical decoupling structures may independently be periodic or random in either or both the X and Y directions. More than one shape of optical decoupling structure can be used, and the orientation of the optical decoupling structures can be independently varied (e.g., some may have their long axis running north-south, and others east-west). It is noted that highly periodic arrangements of optical decoupling structures can lead to artifacts in the visual performance of the optical film assembly, so some degree of randomness is preferred.

Embodiments of optical film assemblies described herein are useful, for example, for hiding optical defects and improving the brightness uniformity of light emitted by a backlight or other light source.

Exemplary Embodiments described in this disclosure include:
1. An optical film assembly, comprising:
a light redirecting film having a first structured major surface and a second, opposed major surface;
an optical adhesive layer on the second major surface of the light redirecting film;
a light diffusion film comprising:
   a first major surface and a second, opposed major surface; and
   a plurality of discrete optical decoupling structures projecting from the first major surface of the light diffusion film and contacting the optical adhesive layer; and
an air gap defined between the first major surface of the light diffusion film and the optical adhesive layer.
   2. The optical film assembly of Exemplary Embodiment 1, wherein each of the optical decoupling structures has a first end at the first major surface of the light diffusion film and a second, opposed end embedded in the optical adhesive layer.
   3. The optical film assembly of any preceding Exemplary Embodiment, wherein the light diffusion film and the optical decoupling structures have the same material composition.
   4. The optical film assembly of Exemplary Embodiment 3, wherein the light diffusion film and the optical decoupling structures comprise at least one of polyacrylate, polymethacrylate, polycarbonate, polyethylene terephthalate, polyethylene naphthalate, polystyrene, cyclic olefin polymers, or co-polymer thereof (including combinations thereof).
   5. The optical film assembly of any preceding Exemplary Embodiment, wherein the first major surface of the light diffusion film defines a microstructured surface comprising a light diffusion surface and the optical decoupling structures.
   6. The optical film assembly of any preceding Exemplary Embodiment, wherein the optical decoupling structures extend through the optical adhesive layer and contact the second major surface of the light redirecting film.
   7. The optical film assembly of any of Exemplary Embodiments 1 to 5, wherein the optical decoupling structures penetrate through only a portion of the optical adhesive layer.
   8. The optical film assembly of any preceding Exemplary Embodiment, wherein the optical decoupling structures are distributed uniformly across the first major surface of the light diffusion film.
   9. The optical film assembly of any preceding Exemplary Embodiment, wherein the optical decoupling structures are distributed uniformly across the first major surface of the light diffusion film and aligned randomly relative to one another.
   10. The optical film assembly of any preceding Exemplary Embodiment, wherein the optical decoupling structures cover less than 20 (in some embodiments, less than 15, 10, or even less than 5; in some embodiments, in a range from 3 to 50; 5 to 20, or even 5 to 10) percent by area of the first major surface of the light diffusion film.
   11. The optical film assembly of any preceding Exemplary Embodiment, wherein the optical decoupling structures have a height in a range from 3 to 20 (in some embodiments, in a range from 3 to 10, 4 to 8 or even 5 to 6) micrometers.
   12. The optical film assembly of any preceding Exemplary Embodiment, wherein the optical decoupling structures have a length in a range from 10 to 70 (in some embodiments, in a range from 20 to 50, or even 30 to 40) micrometers.
   13. The optical film assembly of any preceding Exemplary Embodiment, wherein the optical decoupling structures have a width in a range from 4 to 20 (in some embodiments, in a range from 4 to 10, or even 6 to 8) micrometers.
   14. The optical film assembly of any preceding Exemplary Embodiment, wherein a cross-section of each optical decoupling structure in a direction perpendicular to a length of the optical decoupling structure is U-shaped.
   15. The optical film assembly of any of Exemplary Embodiments 1 to 13, wherein a cross-section of each optical decoupling structure in a direction perpendicular to a length of the optical decoupling structure is V-shaped.
   16. The optical film assembly of any of Exemplary Embodiments 1 to 13, wherein a cross-section of each optical decoupling structure in a direction perpendicular to a length of the optical decoupling structure has a rectangular shape.
   17. The optical film assembly of any of Exemplary Embodiments 1 to 13, wherein the optical decoupling structures have a curved shape.
   18. The optical film assembly of any of Exemplary Embodiments 1 to 13, wherein the optical decoupling structures have a rounded canoe shape.
   19. The optical film assembly of any of Exemplary Embodiments 1 to 13, wherein each optical decoupling structure has a tip region comprising structures that increase a contact area between each optical decoupling structure and the optical adhesive layer.
   20. The optical film assembly of any preceding Exemplary Embodiment, wherein the optical adhesive layer comprises at least one of a pressure sensitive adhesive, a heat-sensitive adhesive, a solvent-volatile adhesive, or a UV-curable adhesive.
   21. The optical film assembly of any preceding Exemplary Embodiment, wherein the light diffusion film has an optical haze in a range from 80 to 100% (in some embodiments, in a range from 85 to 95% or 90 to 95%).
   22. The optical film assembly of any preceding Exemplary Embodiment, wherein the light diffusion film has an optical haze of at least 90 (in some embodiments, at least 91, 92, 93, 94, 95, 96, 97, 98 or even at least 99) %.
   23. The optical film assembly of any preceding Exemplary Embodiment, wherein the light diffusion film has an optical clarity of less than 15 (in some embodiments, less than 10%; in some embodiments in a range from 0 to 50) %.
   24. The optical film assembly of any preceding Exemplary Embodiment, wherein the air gap has a height of at least 0.5 (in some embodiments, at least 0.8, 1.0, or even at least 1.2; in some embodiments in a range from 0.9 to 1.1) micrometers.
   25. The optical film assembly of any preceding Exemplary Embodiment, wherein the optical film assembly has a thickness of less than 110 (in some embodiments, less than 100, or even less than 90; in some embodiments, in a range from 50 to 500) micrometers.
   26. The optical film assembly of any preceding Exemplary Embodiment, comprising a first light redirecting film adjacent a second redirecting film.
   27. The optical film assembly of Exemplary Embodiment 26, wherein the optical film assembly has a thickness of less than 130 (in some embodiments, less than 125, or even less than 120; in some embodiments, in a range from 50 to 500) micrometers.
   28. An optical film assembly, comprising:

a light redirecting film having a first structured major surface and a second, opposed major surface;

an optical adhesive layer on the second major surface of the light redirecting film;

a light diffusion film comprising a first major surface and a second, opposed major surface, the first major surface of the light diffusion film defining a microstructured surface comprising a light diffusion surface and a plurality of discrete optical decoupling structures, each of the optical decoupling structures having a first end at the first major surface of the light diffusion film and a second, opposed end contacting the optical adhesive layer; and

an air gap defined between the first major surface of the light diffusion film and the optical adhesive layer.

29. The optical film assembly of Exemplary Embodiment 28, wherein each of the optical decoupling structures has a first end at the first major surface of the light diffusion film and a second, opposed end embedded in the optical adhesive layer.
30. The optical film assembly of Exemplary Embodiment 28 or 29, wherein the light diffusion film and the optical decoupling structures have the same material composition.
31. The optical film assembly of Exemplary Embodiment 30, wherein the light diffusion film and the optical decoupling structures comprise at least one of polyacrylate, polymethacrylate, polycarbonate, polyethylene terephthalate, polyethylene naphthalate, polystyrene, cyclic olefin polymers, or co-polymer thereof (including combinations thereof).
32. The optical film assembly of any of Exemplary Embodiments 28 to 31, wherein the optical decoupling structures extend through the optical adhesive layer and contact the second major surface of the light redirecting film.
33. The optical film assembly of any of Exemplary Embodiments 28 to 31, wherein the optical decoupling structures penetrate through only a portion of the optical adhesive layer.
34. The optical film assembly of any of Exemplary Embodiments 28 to 33, wherein the optical decoupling structures are distributed uniformly across the first major surface of the light diffusion film.
35. The optical film assembly of any of Exemplary Embodiments 28 to 34, wherein the optical decoupling structures are distributed uniformly across the first major surface of the light diffusion film and aligned randomly relative to one another.
36. The optical film assembly of any of Exemplary Embodiments 28 to 35, wherein the optical decoupling structures cover less than 20 (in some embodiments, less than 15, 10, or even less than 5; in some embodiments, in a range from 3 to 50; 5 to 20, or even 5 to 10) percent by area of the first major surface of the light diffusion film.
37. The optical film assembly of any of Exemplary Embodiments 28 to 36, wherein the optical decoupling structures have a height in a range from 3 to 20 (in some embodiments, in a range from 3 to 10, 4 to 8, or even 5 to 6) micrometers.
38. The optical film assembly of any of Exemplary Embodiments 28 to 37, wherein the optical decoupling structures have a length in a range from 10 to 70 (in some embodiments, in a range from 20 to 50, or even 30 to 40) micrometers.
39. The optical film assembly of any of Exemplary Embodiments 28 to 38, wherein the optical decoupling structures have a width in a range from 4 to 20 (in some embodiments, in a range from 4 to 10 (in some embodiments, in a range from 6 to 8) micrometers.
40. The optical film assembly of any of Exemplary Embodiments 28 to 39, wherein a cross-section of each optical decoupling structure in a direction perpendicular to a length of the optical decoupling structure is U-shaped.
41. The optical film assembly of any of Exemplary Embodiments 28 to 39, wherein a cross-section of each optical decoupling structure in a direction perpendicular to a length of the optical decoupling structure is V-shaped.
42. The optical film assembly of any of Exemplary Embodiments 28 to 39, wherein a cross-section of each optical decoupling structure in a direction perpendicular to a length of the optical decoupling structure has a rectangular shape.
43. The optical film assembly of any of Exemplary Embodiments 28 to 39, wherein the optical decoupling structures have a curved shape.
44. The optical film assembly of any of Exemplary Embodiments 28 to 39, wherein the optical decoupling structures have a rounded canoe shape.
45. The optical film assembly of any of Exemplary Embodiments 28 to 39, wherein the optical decoupling structures have a tip region comprising structures that increase a contact area between the optical decoupling structures and the optical adhesive layer.
46. The optical film assembly of any of Exemplary Embodiments 28 to 45, wherein the optical adhesive layer comprises at least one of a pressure sensitive adhesive, a heat-sensitive adhesive, a solvent-volatile adhesive, or a UV-curable adhesive.
47. The optical film assembly of any of Exemplary Embodiments 28 to 46, wherein the light diffusion film has an optical haze in a range from 50 to 100 (in some embodiments, in a range from 80 to 100%, 85 to 95% or 90 to 95) %.
48. The optical film assembly of any of Exemplary Embodiments 28 to 47, wherein the light diffusion film has an optical haze of at least 90 (in some embodiments, at least 91, 92, 93, 94, 95, 96, 97, 98 or even at least 99) %.
49. The optical film assembly of any of Exemplary Embodiments 28 to 48, wherein the light diffusion film has an optical clarity of less than 15% (in some embodiments, less than 10%; in some embodiments in a range from 0 to 50) %.
50. The optical film assembly of any of Exemplary Embodiments 28 to 49, wherein the air gap has a height of at least 0.5 (in some embodiments, at least 0.8, 1.0, or even at least 1.2; in some embodiments in a range from 0.9 to 1.1) micrometers.
51. The optical film assembly of any of Exemplary Embodiments 28 to 50, wherein the optical film assembly has a thickness of less than 110 (in some embodiments, less than 100, or even less than 90; in some embodiments, in a range from 50 to 500) micrometers.
52. The optical film assembly of any of Exemplary Embodiments 28 to 51, comprising a first light redirecting film adjacent a second redirecting film.
53. The optical film assembly of Exemplary Embodiment 52, wherein the optical film assembly has a thickness of less than 130 (in some embodiments, less than 125, or even less than 120; in some embodiments, in a range from 50 to 500) micrometers.

### EXAMPLES

These examples are merely for illustrative purposes only and are not meant to be limiting on the scope of the appended claims. All parts, percentages, ratios, etc. in the examples and the rest of the specification are by weight, unless noted otherwise. Materials used in the Examples and their sources are provided in Table 1, below. Unless otherwise specified, all commercial materials were used as obtained from the vendor. Unless otherwise specified in Table 1, below, materials can be obtained from Millipore-Sigma Corp., St. Louis, Mo.

TABLE 1

| Materials | Supplier |
|---|---|
| 20 micrometers (0.92 mil) PET | 3M Company, St. Paul, MN |
| primed on both sides | |
| Aliphatic urethane diacrylate | IGM Resins USA, Inc., |
| (obtained under the trade | Charlotte, NC |
| designation “PHOTOMER 6210”) | |
| 1,6-Hexanediol diacrylate (obtained | Sartomer Americas, Exton, PA |
| under the trade designation | |
| “SARTOMER SR238”) | |
| Trimethylolpropane triacrylate | Sartomer Americas |
| (obtained under the trade | |
| designation “SARTOMER SR351”) | |
| Diphenyl(2,4,6- | Millipore-Sigma Corp., |
| trimethylbenzoyl)phosphine | St. Louis, MO |
| oxide (TPO photoinitiator) | |
| Acrylate copolymer (60 wt. % solid | 3M Company |
| in methyl ethyl ketone, Mw = 398,000 | |
| g/mol) | |
| Aliphatic polyester-based urethane | Allnex USA, Inc., Alpharetta, |
| diacrylate oligomer (obtained under | GA |
| the trade designation “EBECRYL | |
| 230” (5,000 g/mol)) | |
| Low viscosity aromatic acrylic | Sartomer Americas |
| oligomer with hydroxyl functionality | |
| (obtained under the trade | |
| designation “SARTOMER CN3100”) | |
| 1-Hydroxycyclohexyl phenyl ketone | BASF Corporation, Florham |
| (obtained under the trade | Park, NJ |
| designation “IRGACURE 184”) | |
| Aliphatic polyester-based urethane | Sartomer Americas |
| diacrylate oligomer (obtained under | |
| the trade designation “SARTOMER | |
| CN983”) | |
| Isocyanatoethyl methacrylate (IEM) | Showa Denko Kanagawa, Japan |
| Methyl Ethyl Ketone (MEK) | Millipore-Sigma Corp. |
| 1-Methoxy-2-propanol | Millipore-Sigma Corp. |

### 1. Preparation of a Light Redirecting Film

A light redirecting film, a schematic perspective-view of which is illustrated in FIG. 1B, was made. A microreplication tool was made using the processes outlined and described in Paragraph [0049] and shown in FIG. 3 of U.S. Pat. Pub. No. 2009/0041553 A1 (Burke et al.), the disclosure of which is incorporated in its entirety herein by reference. The microreplication tool was then used to make light redirecting film using the processes outlined and described in Example 21 (column 13, lines 20-62) of U.S. Pat. No. 5,175,030 (Lu et al.), the disclosure of which is incorporated in its entirety herein by reference. Light redirecting film included a structured layer disposed on a substrate. The substrate was made of PET, had a thickness of about 20 micrometers (0.92 mil), and an index of refraction of about 1.65. The structured layer included a plurality of linear prisms that extended along the y-direction (cross-web direction). The structured layer was fabricated using a resin comprising aliphatic urethane diacrylate (“PHOTOMER 6210”) (60 weight percent (wt. %)), 1,6-Hexanediol diacrylate (“SARTOMER SR238”) (20 wt. %), and trimethylolpropane triacrylate (“SARTOMER SR351”) (20 wt. %). To this resin was added 0.5 wt. % TPO photoinitiator. An apex angle of each prism was about 90 degrees. The prism had a pitch P1 of about 24 micrometers along the x-direction.

2. Preparation of a Film with High Haze Diffuse Structures and Optical Decoupling Structures (ODS)

A diffusion film, a schematic side-view of which is illustrated in FIG. 1A, comprising primary diffusion structures and optical decoupling structures (ODS) was made. Tooling for creating the primary diffusion structures was produced according to the methods disclosed in Paragraphs [0119-0124] of U.S. Pat. Pub. No. 2015/0293272 A1 (Pham et al.), the disclosure of which is incorporated in its entirety herein by reference.

The tool comprising the primary diffusion structures was moved to a secondary operation where the surface of the tool was registered to a secondary material removal process. The secondary processes included diamond turning, for adding ODS structures to the tool. In this process, ODS patterns of defined size, shape, height, and density were controlled to the desired properties and removed relative to the primary diffused surface of the tool.

The tool comprising the primary diffusion structures and ODS structures was plated with a thin layer of chromium metal, as described in Paragraphs [0113-0115] of U.S. Pat. Pub. No. 2015/0293272 A1 (Pham et al.). The diffusion film comprising the primary diffusion structures and the ODS structures was produced using this tool according to the process described in paragraphs [0117-0124] of U.S. Pat. Pub. No. 2015/0293272 A1 (Pham et al.). The resin used for the primary diffusion structures and ODS structures is described in Example 2 (column 21, lines 4-29) of U.S. Pat. No. 8,282,863 (Jones et al.).

### 3. Adhesive and Lamination

### Preparation of Stock Solution 1:

Table 2, below, provides the reagents and their parts of the formulation by weight.

TABLE 2

| | Amount, |
|---|---|
| Material | grams |
| Aliphatic polyester-based urethane diacrylate oligomer | 463.2 |
| (“SARTOMER CN983”) | |
| Low viscosity aromatic acrylic oligomer with hydroxyl | 193 |
| functionality (“SARTOMER CN3100”) | |
| Aliphatic polyester-based urethane diacrylate oligomer | 386 |
| (“EBECRYL 230”) | |
| Methyl ethyl ketone (MEK) | 463 |
| 1-Methoxy-2-propanol | 579 |

A 1 gallon (3.8 liter) jar was charged with 463.2 grams of an aliphatic polyester-based urethane diacrylate oligomer (“SARTOMER CN983”), 193 grams of a low viscosity aromatic acrylic oligomer with hydroxyl functionality (“SARTOMER CN3100”), 386 grams of an aliphatic polyester-based urethane diacrylate oligomer (“EBECRYL 230”), 463 grams of MEK, and 579 grams of 1-methoxy-2-propanol. The mixture was put on a roller for 6 hours to form a homogenous stock solution at 50 wt. % solids.

### Preparation of Stock Solution 2:

Table 3, below, provides the reagents and their parts of the formulation by weight.

TABLE 3

| | Amount, | Solids, |
|---|---|---|
| Material | grams | grams |
| Acrylate copolymer (60 wt. % solid in methyl | 1783 | 1069.8 |
| ethyl ketone, Mw = 398,000 g/mol) | | |
| Methyl ethyl ketone (MEK) | 3819 | |
| Isocyanatoethyl methacrylate (IEM) | 2.56 | 2.56 |
| Total | 5604.56 | 1072.36 |

A 2 gallon (7.6 liter) jar was charged with a solution comprising 1069.8 grams of the acrylate copolymer in 713.2 grams of MEK, an additional 3819 grams of MEK, and 2.56 grams of IEM, totaling 5604.56 grams. The acrylate copolymer was a random copolymer having molecular weight of 398,000 g/mol and comprising 65 wt. % 2-ethylhexyl acrylate, 15 wt. % isobornyl acrylate, 16 wt. % 2-hydroxyethyl acrylate, and 4 wt. % acrylamide (all monomers obtained from Millipore-Sigma Corp.). The mixture was put on a roller for 6 hours to form a homogenous stock solution at 19.13 wt. % solids.

### Preparation of Adhesive Coating Formulation:

The Stock Solution 2 prepared above was combined with 1650 grams of the Stock Solution 1, 2475 grams 1-methoxy-2-propanol, and 30.6 grams of 1-Hydroxycyclohexyl phenyl ketone (“IRGACURE 184”) with mixing to form a clear adhesive coating formulation.

### Adhesive Coating Process:

A syringe-pump at a flow rate of 5.7 cm³/min. was used to pump the adhesive coating formulation into a 20.8-cm (8-inch) wide slot-type coating die. The slot coating die uniformly distributed a 20.8-cm wide coating onto the second major surface of the microstructured film at a rate of 5 ft./min. (152 cm/min.). The solvents were removed by transporting the assembly to a drying oven operating at 200° F. (93.3° C.) for 2 minutes at a web speed of 5 ft./min. (152 cm/min.).

### Lamination:

After drying, the film comprising primary diffusion structures and ODS structures was laminated onto the adhesive coating-side of the microstructured film through an on-line laminator, where the ODS structures were inserted into the adhesive coating. Next, the laminated film structure was post-cured using a UV fusion chamber (obtained under the trade designation “FUSION SYSTEM MODEL I300P” from Fusion UV Systems, Gaithersburg, Md.) and a UV bulb (obtained under the trade designation “H-BULB” from Fusion UV Systems), operated at full power. The UV fusion chamber was supplied with a flow of nitrogen that resulted in an oxygen concentration of about 50 ppm in the chamber.

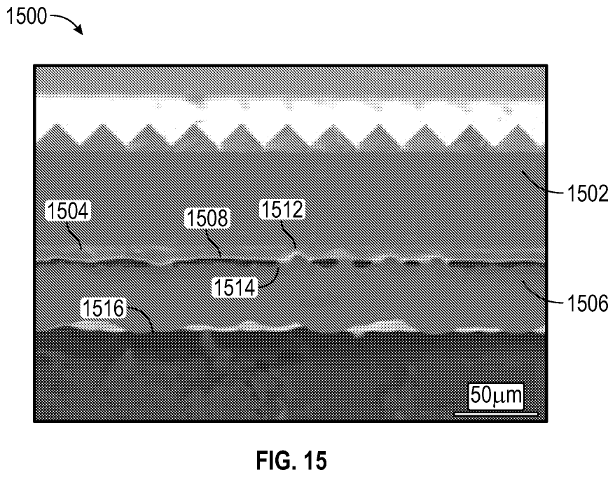

FIG. 15 is an SEM of optical film assembly 1500 according to this Example. Optical film assembly 1500 included light redirecting film 1502, optical adhesive layer 1504, light diffusion film 1506, and air gap 1508 between light diffusion film 1506 and optical adhesive layer 1504. Light diffusion film 1506 includes first major surface comprising light diffusion surface 1514 and optical decoupling structures 1512 projecting from light diffusion surface 1514. Second major surface of light diffusion film 1506 includes light diffusion surface 1516.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

Various modifications and alterations of the embodiments discussed above will be apparent to those skilled in the art, and it should be understood that this disclosure is not limited to the illustrative embodiments set forth herein. The reader should assume that features of one disclosed embodiment can also be applied to all other disclosed embodiments unless otherwise indicated. It should also be understood that all U.S. patents, patent applications, patent application publications, and other patent and non-patent documents referred to herein are incorporated by reference, to the extent they do not contradict the foregoing disclosure.

1. An optical film assembly, comprising:
a light redirecting film having a first structured major surface and a second, opposed major surface;
an optical adhesive layer on the second major surface of the light redirecting film;
a light diffusion film comprising:
a first major surface comprising a light diffusion surface and a second, opposed major surface; and
a plurality of discrete optical decoupling structures projecting from the light diffusion surface and contacting the optical adhesive layer; and
an air gap defined between the first major surface of the light diffusion film and the optical adhesive layer.

2. The optical film assembly of claim 1, wherein the light diffusion surface and the optical decoupling structures have the same material composition.

3. The optical film assembly of claim 2, wherein the light diffusion film and the optical decoupling structures comprise at least one of polyacrylate, polymethacrylate, polycarbonate, polyethylene terephthalate, polyethylene naphthalate, polystyrene, cyclic olefin polymers, or co-polymer thereof.

4. The optical film assembly of claim 1, wherein the optical decoupling structures have a height in a range from 3 to 20 micrometers.

5. The optical film assembly of claim 1, wherein the optical decoupling structures have a length in a range from 10 to 70 micrometers.

6. The optical film assembly of claim 1, wherein the optical decoupling structures have a width in a range from 4 to 20 micrometers.

7. The optical film assembly of claim 1, wherein the optical decoupling structures cover less than 20 percent by area of the first major surface of the light diffusion film.

8. The optical film assembly of claim 1, wherein the light diffusion film has an optical haze in a range from 80 to 100%.

9. The optical film assembly of claim 1, wherein the light diffusion film has an optical clarity of less than 15%.

10. The optical film assembly of claim 1, wherein the optical film assembly has a thickness of less than 120 micrometers.

11. An optical film assembly, comprising:
a light redirecting film having a first structured major surface and a second, opposed major surface;
an optical adhesive layer on the second major surface of the light redirecting film;
a light diffusion film comprising a first major surface and a second, opposed major surface, the first major surface of the light diffusion film defining a microstructured surface comprising a light diffusion surface and a plurality of discrete optical decoupling structures, each of the optical decoupling structures having a first end at the first major surface of the light diffusion film and a second, opposed end contacting the optical adhesive layer; and
an air gap defined between the first major surface of the light diffusion film and the optical adhesive layer.

12. The optical film assembly of claim 11, wherein the light diffusion surface and the optical decoupling structures have the same material composition.

13. The optical film assembly of claim 11, wherein the light diffusion film and the optical decoupling structures comprise at least one of polyacrylate, polymethacrylate, polycarbonate, polyethylene terephthalate, polyethylene naphthalate, polystyrene, cyclic olefin polymers, or co-polymer thereof.

14. The optical film assembly of any of claim 11, wherein the optical decoupling structures have a height in a range from 3 to 20 micrometers.

15. The optical film assembly of claim 11, wherein the optical decoupling structures have a length in a range from 10 to 70 micrometers.

16. The optical film assembly of claim 11, wherein the optical decoupling structures have a width in a range from 4 to 20 micrometers.

17. The optical film assembly of claim 11, wherein the optical decoupling structures cover less than 20 percent by area of the first major surface of the light diffusion film.

18. The optical film assembly of any of claim 11, wherein the light diffusion film has an optical haze in a range from 80 to 100%.

19. The optical film assembly of claim 11, wherein the light diffusion film has an optical clarity of less than 15%.

20. The optical film assembly of claim 11, wherein the optical film assembly has a thickness of less than 120 micrometers.
